(19) United States
(12) Patent Application Publication
(10) Pub. No.: US 2024/0338638 A1
(43) Pub. Date: Oct. 10, 2024

(54) SYSTEMS AND METHODS FOR PROVIDING FEEDBACK TO ONE OR MORE DEVELOPERS

(71) Applicant: Engineer.ai Corp., Salt Lake City, UT (US)

(72) Inventors: Sachin Dev Duggal, Salt Lake City, UT (US); Lalit Kumar Maurya, Salt Lake City, UT (US); Ashesh Ayush Mishra, Salt Lake City, UT (US); Rohan Patel, London (GB)

(73) Assignee: Engineer.ai Corp., Salt Lake City, UT (US)

(21) Appl. No.: 18/296,981

(22) Filed: Apr. 6, 2023

(51) Int. Cl. G06Q 10/0639

(52) U.S. Cl. CPC G06Q 10/06398

(57) ABSTRACT

Systems and methods for providing feedback to one or more developers is disclosed. The system includes a processor coupled to a memory. The processor is configured to determine the one or more developers for completing the one or more projects. The one or more developers are determined based on one or more parameters. The processor is further configured to provide feedback to the one or more developers while working on the one or more projects. In addition, the processor is configured to generate a feedback report for the one or more developers based on the provided feedback. The feedback report is accessible to one or more authorized persons within an entity that has requested to complete the one or more projects.

### FIELD

This disclosure relates to project management, and more particularly to systems and methods for assessing and providing real-time feedback to one or more developers selected for completing one or more projects.

### BACKGROUND

Project management refers to leading an entity to achieve project goals within specific deadlines. In the case of complex and lengthy projects, multiple developers/people would be desired in order to timely and efficiently finish each stage of the projects. Recruiting an appropriate set of developers/people for the job is a challenging task. Further, if the projects have multiple stages and tasks to be executed, multiple managers would be expected to monitor the status and progress of the different stages and tasks. This monitoring progress would be difficult and time-consuming as a lot of manual effort would be expected from the managers. Thus, there is a need in the art for a more efficient way to onboard people and provide real-time inputs to them while working, to ensure that the projects assigned to them are completed on time.

### SUMMARY

The disclosed subject matter relates to a system for onboarding one or more developers. The system includes a processor coupled to a memory. The processor is configured to receive an application request from the one or more developers. The processor is further configured to evaluate the one or more developers based on an evaluation criteria. In addition, the processor is configured to generate an onboarding score for the one or more developers based on the evaluation criteria. The onboarding score indicates a capability of the one or more developers.

The disclosed subject matter also relates to a method for onboarding one or more developers. The method includes receiving an application request from the one or more developers. The method further includes evaluating the one or more developers based on an evaluation criteria. In addition, the method includes generating an onboarding score for the one or more developers based on the evaluation criteria. The onboarding score indicates a capability of the one or more developers.

The disclosed subject matter also relates to a computer readable storage medium having data stored therein representing software executable by a computer, the software comprising instructions that, when executed, cause the computer readable storage medium to perform receiving an application request from one or more developers. The instructions further cause the computer readable storage medium to perform evaluating the one or more developers based on an evaluation criteria. The instructions further cause the computer readable storage medium to perform generating an onboarding score for the one or more developers based on the evaluation criteria. The onboarding score indicates a capability of the one or more developers. The instructions further cause the computer readable storage medium to perform comparing the onboarding score with a threshold limit. The instructions further cause the computer readable storage medium to perform grouping the one or more developers into one or more groups based on the comparing between the onboarding score and the threshold limit. The one or more groups include a beginner group, an intermediate group, and an advanced group. The instructions further cause the computer readable storage medium to perform assigning one or more projects to the one or more developers based on the groups that they are grouped into. In addition, the instructions further cause the computer readable storage medium to assessing the one or more developers while working on each project based on one or more parameters.

The disclosed subject matter further relates to a system for assessing one or more developers. The system includes a processor coupled to a memory. The processor is configured to communicate to one or more developers selected, a project workflow to complete one or more projects. The processor is further configured to assess the one or more developers while working on the one or more projects. The assessment of the one or more developers is based on an assessment criteria. The processor is further configured to generate an assessment score for the one or more developers based on the assessment criteria. In addition, the processor is configured to generate a rate card for the one or more developers based on the assessment criteria.

The disclosed subject matter also relates to a method for assessing one or more developers. The method includes communicating to one or more developers selected, a project workflow to complete one or more projects. The method further includes assessing the one or more developers while working on the one or more projects. The assessment of the one or more developers is based on an assessment criteria. The method further includes generating an assessment score for the one or more developers based on the assessment criteria. In addition, the method includes generating a rate card for the one or more developers based on the assessment criteria.

The disclosed subject matter also relates to a computer readable storage medium having data stored therein representing software executable by a computer, the software comprising instructions that, when executed, cause the computer readable storage medium to perform communicating a project workflow to complete one or more projects to one or more developers. The instructions further cause the computer readable storage medium to perform assessing the one or more developers while working on the one or more projects. The assessment of the one or more developers is based on an assessment criteria. The instructions further cause the computer readable storage medium to perform generating an assessment score for the one or more developers based on the assessment criteria. The instructions further cause the computer readable storage medium to perform generating a rate card for the one or more developers based on the assessment criteria. The instructions further cause the computer readable storage medium to perform reviewing one or more inputs from the one or more developers to modify the rate card. The instructions further cause the computer readable storage medium to perform generating a revised rate card based on the one or more inputs received upon an acknowledgement from the one or more developers. In addition, the instructions cause the computer readable storage medium to perform assigning one or more new projects to the one or more developers based on the revised rate card.

In addition, the disclosed subject matter relates to a system for providing feedback to one or more developers working on one or more projects. The system includes a processor coupled to a memory. The processor is configured to determine the one or more developers for completing the one or more projects. The one or more developers are determined based on one or more parameters. The processor is further configured to provide feedback to the one or more developers while working on the one or more projects. In addition, the processor is configured to generate a feedback report for the one or more developers based on the provided feedback. The feedback report is accessible to one or more authorized persons within an entity that has requested to complete the one or more projects.

The disclosed subject matter also relates to a method for providing feedback to one or more developers working on one or more projects. The method includes determining the one or more developers for completing the one or more projects. The one or more developers are determined based on one or more parameters. The method further includes providing feedback to the one or more developers while working on the one or more projects. In addition, the method includes generating a feedback report for the one or more developers based on the provided feedback. The feedback report is accessible to one or more authorized persons within an entity that has requested to complete the one or more projects.

The disclosed subject matter also relates to a computer readable storage medium having data stored therein representing software executable by a computer, the software comprising instructions that, when executed, cause the computer readable storage medium to perform determining the one or more developers for completing the one or more projects. The one or more developers are determined based on one or more parameters. The instructions further cause the computer readable storage medium to perform providing feedback to the one or more developers while working on the one or more projects. In addition, the instructions cause the computer readable storage medium to perform generating a feedback report for the one or more developers based on the provided feedback. The feedback report is accessible to one or more authorized persons within an entity that has requested to complete the one or more projects.

### BRIEF DESCRIPTION OF THE DRAWINGS

FIG. 1 is a software building system illustrating the components that may be used in an embodiment of the disclosed subject matter.

FIG. 2 is a schematic illustrating an embodiment of the management components of the disclosed subject matter.

FIG. 3 is a schematic illustrating an embodiment of an assembly line and surfaces of the disclosed subject matter.

FIG. 4 is a schematic illustrating an embodiment of the run entities of the disclosed subject matter.

FIG. 5 is a schematic illustrating the computing components that may be used to implement various features of embodiments described in the disclosed subject matter.

FIG. 6 is a schematic illustrating a system in an embodiment of the disclosed subject matter.

FIG. 7 is a schematic illustrating an exploded view of the server of the system of FIG. 6 in an embodiment of the disclosed subject matter.

FIG. 8 is a flow diagram illustrating a method for onboarding one or more developers in an embodiment of the disclosed subject matter.

FIG. 9 is a flow diagram illustrating a method for assessing one or more developers in an embodiment of the disclosed subject matter.

FIG. 10 is a flow diagram illustrating a method for providing feedback to one or more developers working on one or more projects in an embodiment of the disclosed subject matter.

### DETAILED DESCRIPTION

Embodiments, of the present disclosure, will now be described with reference to the accompanying drawing.

Embodiments are provided so as to convey the scope of the present disclosure thoroughly and fully to the person skilled in the art. Numerous details, are set forth, relating to specific components, and methods, to provide a complete understanding of embodiments of the present disclosure. It will be apparent to the person skilled in the art that the details provided in the embodiments may not be construed to limit the scope of the present disclosure. In some embodiments, well-known processes, well-known apparatus structures, and well-known techniques are not described in detail.

The terminology used, in the present disclosure, is for the purpose of explaining a particular embodiment and such terminology may not be considered to limit the scope of the present disclosure. As used in the present disclosure, the forms “a,” “an,” and “the” may be intended to include the plural forms as well, unless the context clearly suggests otherwise. The terms “comprises,” “comprising,” “including,” and “having,” are open ended transitional phrases and therefore specify the presence of stated features, elements, modules, units and/or components, but do not forbid the presence or addition of one or more other features, elements, components, and/or groups thereof. The particular order of steps disclosed in the method and process of the present disclosure is not to be construed as requiring their performance as described or illustrated. It is also to be understood that additional or alternative steps may be employed.

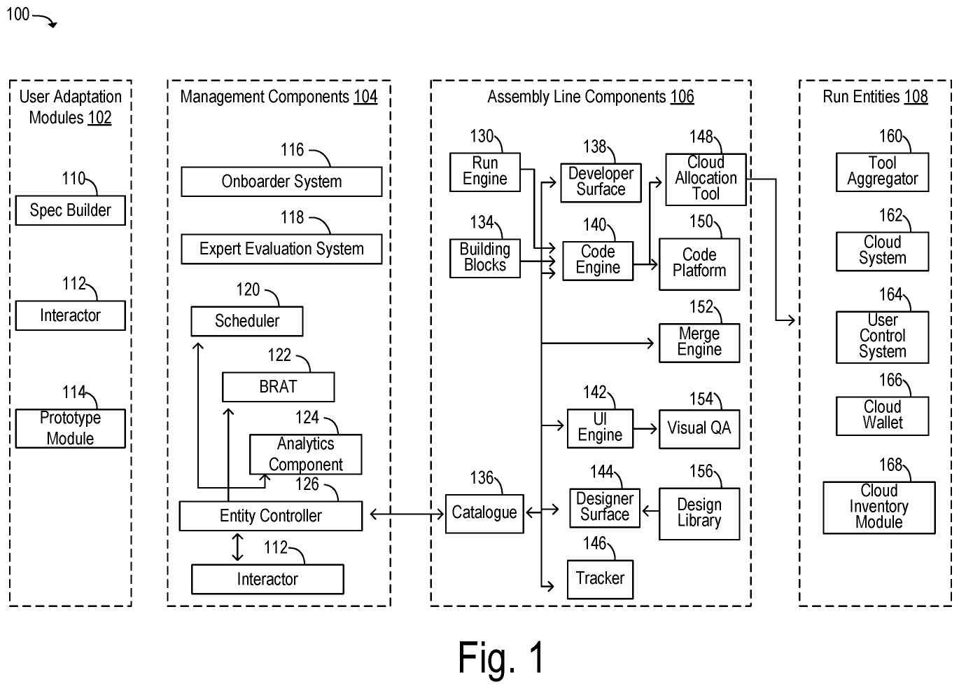

Referring to FIG. 1, FIG. 1 is a schematic of a software building system 100 illustrating the components that may be used in an embodiment of the disclosed subject matter. The software building system 100 is an AI-assisted platform that comprises entities, circuits, modules, and components that enable the use of state-of-the-art algorithms to support producing custom software.

A user may leverage the various components of the software building system 100 to quickly design and complete a software project. The features of the software building system 100 operate AI algorithms where applicable to streamline the process of building software. Designing, building and managing a software project may all be automated by the AI algorithms.

To begin a software project, an intelligent Al conversational assistant may guide users in conception and design of their idea. Components of the software building system 100 may accept plain language specifications from a user and convert them into a computer readable specification that can be implemented by other parts of the software building system 100. Various other entities of the software building system 100 may accept the computer readable specification or buildcard to automatically implement it and/or manage the implementation of the computer readable specification.

The embodiment of the software building system 100 shown in FIG. 1 includes user adaptation modules 102, management components 104, assembly line components 106, and run entities 108. The user adaptation modules 102 entities guide a user during all parts of a project from the idea conception to full implementation. user adaptation modules 102 may intelligently link a user to various entities of the software building system 100.

The user adaptation modules 102 may include a specification builder 110, an interactor 112 system, and the prototype module 114. They may be used to guide a user through a process of building software and managing a software project. The specification builder 110, the interactor 112 system, and the prototype module 114 may be used concurrently and/or link to one another. For instance, the specification builder 110 may accept user specifications that are generated in an interactor 112 system. The prototype module 114 may utilize computer generated specifications that are produced in specification builder 110 to create a prototype for various features. Further, the interactor 112 system may aid a user in implementing all features in specification builder 110 and the prototype module 114.

The specification builder 110 converts user supplied specifications into specifications that can be automatically read and implemented by various objects, instances, or entities of the software building system 100. The machine readable specifications may be referred to herein as a buildcard. In an example of use, specification builder 110 may accept a set of features, platforms, etc., as input and generate a machine readable specification for that project. Specification builder 110 may further use one or more machine learning algorithms to determine a cost and/or timeline for a given set of features. In an example of use, specification builder 110 may determine potential conflict points and factors that will significantly affect cost and timeliness of a project based on training data. For example, historical data may show that a combination of various building block components create a data transfer bottleneck. Specification builder 110 may be configured to flag such issues.

The interactor 112 system is an AI powered speech and conversational analysis system. It converses with a user with a goal of aiding the user. In one example, the interactor 112 system may ask the user a question to prompt the user to answer about a relevant topic. For instance, the relevant topic may relate to a structure and/or scale of a software project the user wishes to produce. The interactor 112 system makes use of natural language processing (NLP) to decipher various forms of speech including comprehending words, phrases, and clusters of phases

In an exemplary embodiment, the NLP implemented by interactor 112 system is based on a deep learning algorithm. Deep learning is a form of a neural network where nodes are organized into layers. A neural network has a layer of input nodes that accept input data where each of the input nodes are linked to nodes in a next layer. The next layer of nodes after the input layer may be an output layer or a hidden layer. The neural network may have any number of hidden layers that are organized in between the input layer and output layers.

Data propagates through a neural network beginning at a node in the input layer and traversing through synapses to nodes in each of the hidden layers and finally to an output layer. Each synapse passes the data through an activation function such as, but not limited to, a Sigmoid function. Further, each synapse has a weight that is determined by training the neural network. A common method of training a neural network is backpropagation. Backpropagation is an algorithm used in neural networks to train models by adjusting the weights of the network to reduce the difference between predicted and actual outputs. During training, backpropagation works by propagating the error back through the network, layer by layer, and updating the weights in the opposite direction of the gradient of the loss function. By repeating this process over many iterations, the network gradually learns to produce more accurate outputs for a given input.

Various systems and entities of the software building system 100 may be based on a variation of a neural network or similar machine learning algorithm. For instance, input for NLP systems may be the words that are spoken in a sentence. In one example, each word may be assigned to separate input node where the node is selected based on the word order of the sentence. The words may be assigned various numerical values to represent word meaning whereby the numerical values propagate through the layers of the neural network.

The NLP employed by the interactor 112 system may output the meaning of words and phrases that are communicated by the user. The interactor 112 system may then use the NLP output to comprehend conversational phrases and sentences to determine the relevant information related to the user's goals of a software project. Further machine learning algorithms may be employed to determine what kind of project the user wants to build including the goals of the user as well as providing relevant options for the user.

The prototype module 114 can automatically create an interactive prototype for features selected by a user. For instance, a user may select one or more features and view a prototype of the one or more features before developing them. The prototype module 114 may determine feature links to which the user's selection of one or more features would be connected. In various embodiments, a machine learning algorithm may be employed to determine the feature links. The machine learning algorithm may further predict embeddings that may be placed in the user selected features.

An example of the machine learning algorithm may be a gradient boosting model. A gradient boosting model may use successive decision trees to determine feature links. Each decision tree is a machine learning algorithm in itself and includes nodes that are connected via branches that branch based on a condition into two nodes. Input begins at one of the nodes whereby the decision tree propagates the input down a multitude of branches until it reaches an output node. The gradient boosted tree uses multiple decision trees in a series. Each successive tree is trained based on errors of the previous tree and the decision trees are weighted to return best results.

The prototype module 114 may use a secondary machine learning algorithm to select a likely starting screen for each prototype. Thus, a user may select one or more features and the prototype module 114 may automatically display a prototype of the selected features.

The software building system 100 includes management components 104 that aid the user in managing a complex software building project. The management components 104 allow a user that does not have experience in managing software projects to effectively manage multiple experts in various fields. An embodiment of the management components 104 include the onboarding system 116, an expert evaluation system 118, scheduler 120, BRAT 122, analytics component 124, entity controller 126, and the interactor 112 system.

The onboarding system 116 aggregates experts so they can be utilized to execute specifications that are set up in the software building system 100. In an exemplary embodiment, software development experts may register into the onboarding system 116 which will organize experts according to their skills, experience, and past performance. In one example, the onboarding system 116 provides the following features: partner onboarding, expert onboarding, reviewer assessments, expert availability management, and expert task allocation.

An example of partner onboarding may be pairing a user with one or more partners in a project. The onboarding system 116 may prompt potential partners to complete a profile and may set up contracts between the prospective partners. An example of expert onboarding may be a systematic assessment of prospective experts including receiving a profile from the prospective expert, quizzing the prospective expert on their skill and experience, and facilitating courses for the expert to enroll and complete. An example of reviewer assessments may be for the onboarding system 116 to automatically review completed portions of a project. For instance, the onboarding system 116 may analyze submitted code, validate functionality of submitted code, and assess a status of the code repository. An example of expert availability management in the onboarding system 116 is to manage schedules for expert assignments and oversee expert compensation. An example of expert task allocation is to automatically assign jobs to experts that are onboarded in the onboarding system 116. For instance, the onboarding system 116 may determine a best fit to match onboarded experts with project goals and assign appropriate tasks to the determined experts.

The expert evaluation system 118 continuously evaluates developer experts. In an exemplary embodiment, the expert evaluation system 118 rates experts based on completed tasks and assigns scores to the experts. The scores may provide the experts with critique and provide the onboarding system 116 with metrics with it can use to allocate the experts on future tasks.

Scheduler 120 keeps track of overall progress of a project and provides experts with job start and job completion estimates. In a complex project, some expert developers may be expected to wait until parts of a project are completed before their tasks can begin. Thus, effective time allocation can improve expert developer management. Scheduler 120 provides up to date estimates to expert developers for job start and completion windows so they can better manage their own time and position them to complete their job on time with high quality.

The big resource allocation tool (BRAT 122) is capable of generating developer assignments for all available parallel workstream across multiple projects. BRAT 122 system allows expert developers to be efficiently managed to reduce cost and time. In an exemplary embodiment, the BRAT 122 system considers a plethora of information including feature complexity, developer expertise, past developer experience, time zone, and project affinity to make assignments to expert developers. The BRAT 122 system may make use of the expert evaluation system 118 to determine the best experts for various assignments. Further, the expert evaluation system 118 may be leveraged to provide live grading to experts and employ qualitative and quantitative feedback. For instance, experts may be assigned a live score based on the number of jobs completed and the quality of jobs completed.

The analytics component 124 is a dashboard that provides a view of progress in a project. One of many purposes of the analytics component 124 dashboard is to provide a primary form of communication between a user and the project developers. Thus, offline communication, which can be time consuming and stressful, may be reduced. In an exemplary embodiment, the analytics component 124 dashboard may show live progress as a percentage feature along with releases, meetings, account settings, and ticket sections. Through the analytics component 124 dashboard, dependencies may be viewed and resolved by users or developer experts.

The entity controller 126 is a primary hub for entities of the software building system 100. It connects to scheduler 120, the BRAT 122 system, and the analytics component 124 to provide for continuous management of expert developer schedules, expert developer scoring for completed projects, and communication between expert developers and users. Through the entity controller 126, both expert developers and users may assess a project, make adjustments, and immediately communicate any changes to the rest of the development team.

The entity controller 126 may be linked to the interactor 112 system, allowing users to interact with a live project via an intelligent AI conversational system. Further, the Interactor 112 system may provide expert developers with up-to-date management communication such as text, email, ticketing, and even voice communications to inform developers of expected progress and/or review of completed assignments.

The assembly line components 106 comprise underlying components that provide the functionality to the software building system 100. The embodiment of the assembly line components 106 shown in FIG. 1 includes a run engine 130, building block components 134, catalogue 136, developer surface 138, a code engine 140, a UI engine 142, a designer surface 144, tracker 146, a cloud allocation tool 148, a code platform 150, a merge engine 152, visual QA 154, and a design library 156.

The run engine 130 may maintain communication between various building block components within a project as well as outside of the project. In an exemplary embodiment, the run engine 130 may send HTTP/S GET or POST requests from one page to another.

The building block components 134 are reusable code that are used across multiple computer readable specifications. The term buildcards, as used herein, refer tomachine readable specifications that are generated by specification builder 110, which may convert user specifications into a computer readable specification that contains the user specifications and a format that can be implemented by an automated process with minimal intervention by expert developers.

The computer readable specifications are constructed with building block components 134, which are reusable code components. The building block components 134 may be pretested code components that are modular and safe to use. In an exemplary embodiment, the building block components 134 consists of two sections-core and custom. Core sections comprise the lines of code which represent the main functionality and reusable components across computer readable specifications. The custom sections comprise the snippets of code that define customizations specific to the computer readable specification. This could include placeholder texts, theme, color, font, error messages, branding information, etc.

Catalogue 136 is a management tool that may be used as a backbone for applications of the software building system 100. In an exemplary embodiment, the catalogue 136 may be linked to the entity controller 126 and provide it with centralized, uniform communication between different services.

Developer surface 138 is a virtual desktop with preinstalled tools for development. Expert developers may connect to developer surface 138 to complete assigned tasks. In an exemplary embodiment, expert developers may connect to developer surface from any device connected to a network that can access the software project. For instance, developer experts may access developer surface 138 from a web browser on any device. Thus, the developer experts may work from anywhere across geographic constraints. In various embodiments, the developer surface uses facial recognition to authenticate the developer expert at all times. In an example of use, all code that is typed by the developer expert is tagged with an authentication that is verified at the time each keystroke is made. Accordingly, if code is copied, the source of the copied code may be quickly determined. The developer surface 138 further provides a secure environment for developer experts to complete their assigned tasks.

The code engine 140 is a portion of a code platform 150 that assembles all the building block components required by the build card based on the features associated with the build card. The code platform 150 uses language-specific translators (LSTs) to generate code that follows a repeatable template. In various embodiments, the LSTs are pretested to be deployable and human understandable. The LSTs are configured to accept markers that identify the customization portion of a project. Changes may be automatically injected into the portions identified by the markers. Thus, a user may implement custom features while retaining product stability and reusability. In an example of use, new or updated features may be rolled out into an existing assembled project by adding the new or updated features to the marked portions of the LSTs.

In an exemplary embodiment, the LSTs are stateless and work in a scalable Kubernetes Job architecture which allows for limitless scaling that provide the throughput based on the volume of builds coming in through a queue system. This stateless architecture may also enable support for multiple languages in a plug & play manner.

The cloud allocation tool 148 manages cloud computing that is associated with computer readable specifications. For example, the cloud allocation tool 148 assesses computer readable specifications to predict a cost and resources to complete them. The cloud allocation tool 148 then creates cloud accounts based on the prediction and facilitates payments over the lifecycle of the computer readable specification.

The merge engine 152 is a tool that is responsible for automatically merging the design code with the functional code. The merge engine 152 consolidates styles and assets in one place allowing experts to easily customize and consume the generated code. The merge engine 152 may handle navigations that connect different screens within an application. It may also handle animations and any other interactions within a page.

The UI engine 142 is a design-to-code product that converts designs into browser ready code. In an exemplary embodiment, the UI engine 142 converts designs such as those made in Sketch into React code. The UI engine may be configured to scale generated UI code to various screen sizes without requiring modifications by developers. In an example of use, a design file may be uploaded by a developer expert to designer surface 144 whereby the UI engine automatically converts the design file into a browser ready format.

The visual QA 154 automates the process of comparing design files with actual generated screens and identifies visual differences between the two. Thus, screens generated by the UI engine 142 may be automatically validated by the visual QA 154 system. In various embodiments, a pixel to pixel comparison is performed using computer vision to identify discrepancies on the static page layout of the screen based on location, color contrast and geometrical diagnosis of elements on the screen. Differences may be logged as bugs by scheduler 120 so they can be reviewed by expert developers.

In an exemplary embodiment, visual QA 154 implements an optical character recognition (OCR) engine to detect and diagnose text position and spacing. Additional routines are then used to remove text elements before applying pixel-based diagnostics. At this latter stage, an approach based on similarity indices for computer vision is employed to check element position, detect missing/spurious objects in the UI and identify incorrect colors. Routines for content masking are also implemented to reduce the number of false positives associated with the presence of dynamic content in the UI such as dynamically changing text and/or images.

The visual QA 154 system may be used for computer vision, detecting discrepancies between developed screens, and designs using structural similarity indices. It may also be used for excluding dynamic content based on masking and removing text based on optical character recognition whereby text is removed before running pixel-based diagnostics to reduce the structural complexity of the input images.

The designer surface 144 connects designers to a project network to view all of their assigned tasks as well as create or submit customer designs. In various embodiments, computer readable specifications include prompts to insert designs. Based on the computer readable specification, the designer surface 144 informs designers of designs that are expected of them and provides for easy submission of designs to the computer readable specification. Submitted designs may be immediately available for further customization by expert developers that are connected to a project network.

Similar to building block components 134, the design library 156 contains design components that may be reused across multiple computer readable specifications. The design components in the design library 156 may be configured to be inserted into computer readable specifications, which allows designers and expert developers to easily edit them as a starting point for new designs. The design library 156 may be linked to the designer surface 144, thus allowing designers to quickly browse pretested designs for user and/or editing.

Tracker 146 is a task management tool for tracking and managing granular tasks performed by experts in a project network. In an example of use, common tasks are injected into tracker 146 at the beginning of a project. In various embodiments, the common tasks are determined based on prior projects, completed, and tracked in the software building system 100.

The run entities 108 contain entities that all users, partners, expert developers, and designers use to interact within a centralized project network. In an exemplary embodiment, the run entities 108 include tool aggregator 160, cloud system 162, user control system 164, cloud wallet 166, and a cloud inventory module 168. The tool aggregator 160 entity brings together all third-party tools and services required by users to build, run and scale their software project. For instance, it may aggregate software services from payment gateways and licenses such as Office 365. User accounts may be automatically provisioned for services without the hassle of integrating them one at a time. In an exemplary embodiment, users of the run entities 108 may choose from various services on demand to be integrated into their application. The run entities 108 may also automatically handle invoicing of the services for the user.

The cloud system 162 is a cloud platform that is capable of running any of the services in a software project. The cloud system 162 may connect any of the entities of the software building system 100 such as the code platform 150, developer surface 138, designer surface 144, catalogue 136, entity controller 126, specification builder 110, the interactor 112 system, and the prototype module 114 to users, expert developers, and designers via a cloud network. In one example, cloud system 162 may connect developer experts to an IDE and design software for designers allowing them to work on a software project from any device.

The user control system 164 is a system requiring the user to have input over all features of a final product in a software product. With the user control system 164, automation is configured to allow the user to edit and modify any features that are attached to a software project regardless as to the coding and design by developer experts and designer. For example, building block components 134 are configured to be malleable such that any customizations by expert developers can be undone without breaking the rest of a project. Thus, dependencies are configured so that no one feature locks out or restricts development of other features.

Cloud wallet 166 is a feature that handles transactions between various individuals and/or groups that work on a software project. For instance, payment for work performed by developer experts or designers from a user is facilitated by cloud wallet 166. A user has to set up a single account in cloud wallet 166 whereby cloud wallet handles payments of all transactions.

A cloud allocation tool 148 may automatically predict cloud costs that would be incurred by a computer readable specification. This is achieved by consuming data from multiple cloud providers and converting it to domain specific language, which allows the cloud allocation tool 148 to predict infrastructure blueprints for customers' computer readable specifications in a cloud agnostic manner. It manages the infrastructure for the lifecycle of the computer readable specification (from development to after care) which includes creation of cloud accounts, in predicted cloud providers, along with setting up CI/CD to facilitate automated deployments.

The cloud inventory module 168 handles storage of assets on the run entities 108. For instance, building block components 134 and assets of the design library are stored in the cloud inventory entity. Expert developers and designers that are onboarded by onboarding system 116 may have profiles stored in the cloud inventory module 168. Further, the cloud inventory module 168 may store funds that are managed by the cloud wallet 166. The cloud inventory module 168 may store various software packages that are used by users, expert developers, and designers to produce a software product.

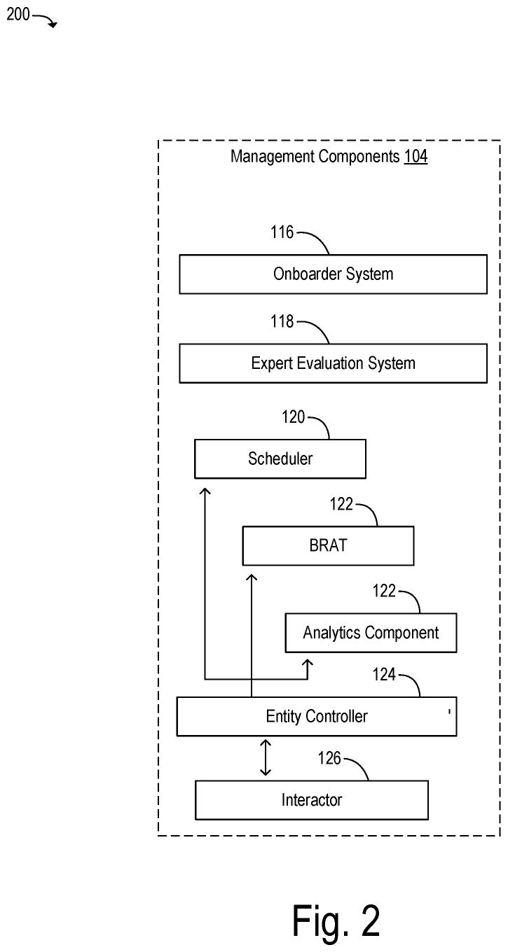

Referring to FIG. 2. FIG. 2 is a schematic 200 illustrating an embodiment of the management components 104 of the software building system 100. The management components 104 provide for continuous assessment and management of a project through its entities and systems. The central hub of the management components 104 is entity controller 126. In an exemplary embodiment, core functionality of the entity controller 126 system comprises the following: display computer readable specifications configurations, provide statuses of all computer readable specifications, provide toolkits within each computer readable specification, integration of the entity controller 126 with tracker 146 and the onboarding system 116, integration code repository for repository creation, code infrastructure creation, code management, and expert management, customer management, team management, specification and demonstration call booking and management, and meetings management.

In an exemplary embodiment, the computer readable specification configuration status includes customer information, requirements, and selections. The statuses of all computer readable specifications may be displayed on the entity controller 126, which provides a concise perspective of the status of a software project. Toolkits provided in each computer readable specification allow expert developers and designers to chat, email, host meetings, and implement 3rd party integrations with users. Entity controller 126 allows a user to track progress through a variety of features including but not limited to tracker 146, the UI engine 142, and the onboarding system 116. For instance, the entity controller 126 may display the status of computer readable specifications as displayed in tracker 146. Further, the entity controller 126 may display a list of experts available through the onboarding system 116 at a given time as well as ranking experts for various jobs.

The entity controller 126 may also be configured to create code repositories. For example, the entity controller 126 may be configured to automatically create an infrastructure for code and to create a separate code repository for each branch of the infrastructure. Commits to the repository may also be managed by the entity controller 126.

Entity controller 126 may be integrated into scheduler 120 to determine a timeline for jobs to be completed by developer experts and designers. The BRAT 122 system may be leveraged to score and rank experts for jobs in scheduler 120. A user may interact with the entity controller 126 features through the analytics component 124 dashboard. Alternatively, a user may interact with the entity controller 126 features via the interactive conversation in the interactor 112 system.

Entity controller 126 may facilitate user management such as scheduling meetings with expert developers and designers, documenting new software such as generating an API, and managing dependencies in a software project. Meetings may be scheduled with individual expert developers, designers, and with whole teams or portions of teams.

Machine learning algorithms may be implemented to automate resource allocation in the entity controller 126. In an exemplary embodiment, assignment of resources to groups may be determined by constrained optimization by minimizing total project cost. In various embodiments a health state of a project may be determined via probabilistic Bayesian reasoning whereby a causal impact of different factors on delays using a Bayesian network are estimated.

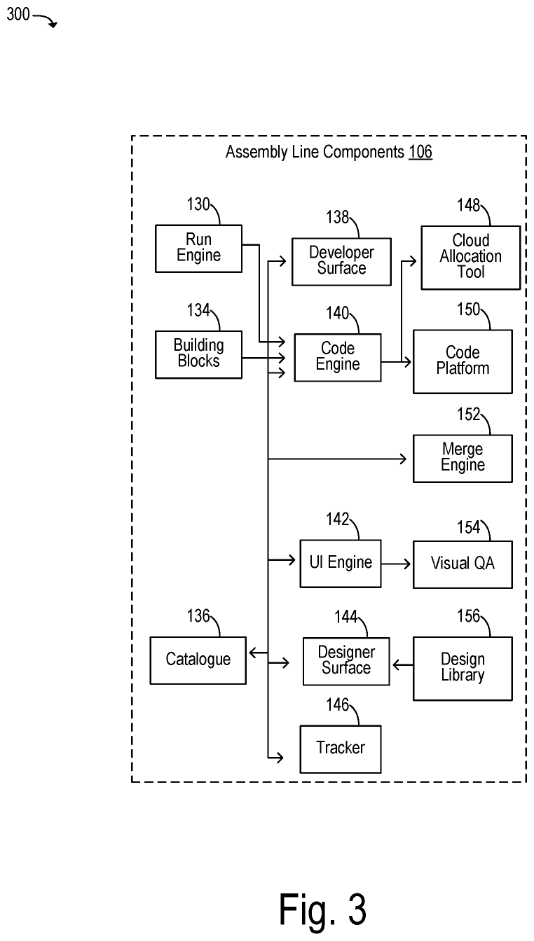

Referring to FIG. 3, FIG. 3 is a schematic 300 illustrating an embodiment of the assembly line components 106 of the software building system 100. The assembly line components 106 support the various features of the management components 104. For instance, the code platform 150 is configured to facilitate user management of a software project. The code engine 140 allows users to manage the creation of software by standardizing all code with pretested building block components. The building block components contain LSTs that identify the customizable portions of the building block components 134.

The machine readable specifications may be generated from user specifications. Like the building block components, the computer readable specifications are designed to be managed by a user without software management experience. The computer readable specifications specify project goals that may be implemented automatically. For instance, the computer readable specifications may specify one or more goals that require expert developers. The scheduler 120 may hire the expert developers based on the computer readable specifications or with direction from the user. Similarly, one or more designers may be hired based on specifications in a computer readable specification. Users may actively participate in management or take a passive role.

A cloud allocation tool 148 is used to determine costs for each computer readable specification. In an exemplary embodiment, a machine learning algorithm is used to assess computer readable specifications to estimate costs of development and design that is specified in a computer readable specification. Cost data from past projects may be used to train one or more models to predict costs of a project.

The developer surface 138 system provides an easy to set up platform within which expert developers can work on a software project. For instance, a developer in any geography may connect to a project via the cloud system 162 and immediately access tools to generate code. In one example, the expert developer is provided with a preconfigured IDE as they sign into a project from a web browser.

The designer surface 144 provides a centralized platform for designers to view their assignments and submit designs. Design assignments may be specified in computer readable specifications. Thus, designers may be hired and provided with instructions to complete a design by an automated system that reads a computer readable specification and hires out designers based on the specifications in the computer readable specification. Designers may have access to pretested design components from a design library 156. The design components, like building block components, allow the designers to start a design from a standardized design that is already functional.

The UI engine 142 may automatically convert designs into web ready code such as React code that may be viewed by a web browser. To ensure that the conversion process is accurate, the visual QA 154 system may evaluate screens generated by the UI engine 142 by comparing them with the designs that the screens are based on. In an exemplary embodiment, the visual QA 154 system does a pixel to pixel comparison and logs any discrepancies to be evaluated by an expert developer.

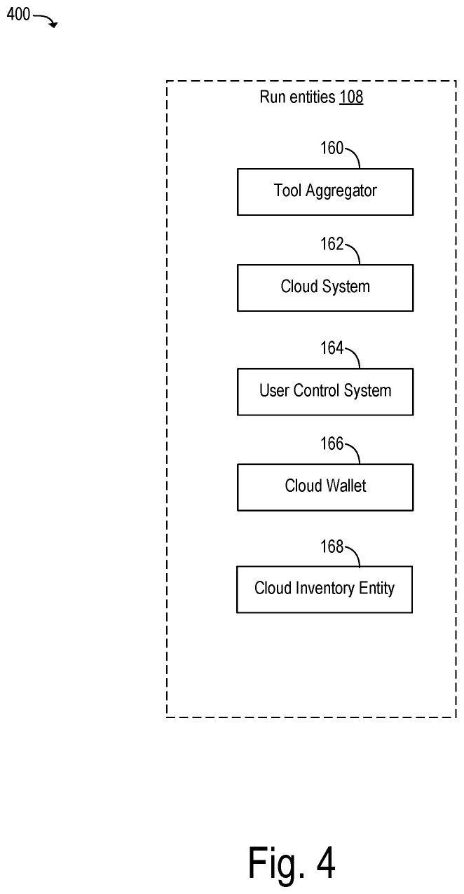

Referring to FIG. 4, FIG. 4 is a schematic 400 illustrating an embodiment of the run entities 108 of the software building system. The run entities 108 provides a user with 3rd party tools and services, inventory management, and cloud services in a scalable system that can be automated to manage a software project. In an exemplary embodiment, the run entities 108 is a cloud-based system that provides a user with all tools to run a project in a cloud environment.

For instance, the tool aggregator 160 automatically subscribes with appropriate 3^{rd} party tools and services and makes them available to a user without a time consuming and potentially confusing set up. The cloud system 162 connects a user to any of the features and services of the software project through a remote terminal. Through the cloud system 162, a user may use the user control system 164 to manage all aspects of a software project including conversing with an intelligent AI in the interactor 112 system, providing user specifications that are converted into computer readable specifications, providing user designs, viewing code, editing code, editing designs, interacting with expert developers and designers, interacting with partners, managing costs, and paying contractors.

A user may handle all costs and payments of a software project through cloud wallet 166. Payments to contractors such as expert developers and designers may be handled through one or more accounts in cloud wallet 166. The automated systems that assess completion of projects such as tracker 146 may automatically determine when jobs are completed and initiate appropriate payment as a result. Thus, accounting through cloud wallet 166 may be at least partially automated. In an exemplary embodiment, payments through cloud wallet 166 are completed by a machine learning AI that assesses job completion and total payment for contractors and/or employees in a software project.

Cloud inventory module 168 automatically manages inventory and purchases without human involvement. For example, cloud inventory module 168 manages storage of data in a repository or data warehouse. In an exemplary embodiment, it uses a modified version of the knapsack algorithm to recommend commitments to data that it stores in the data warehouse. Cloud inventory module 168 further automates and manages cloud reservations such as the tools providing in the tool aggregator 160.

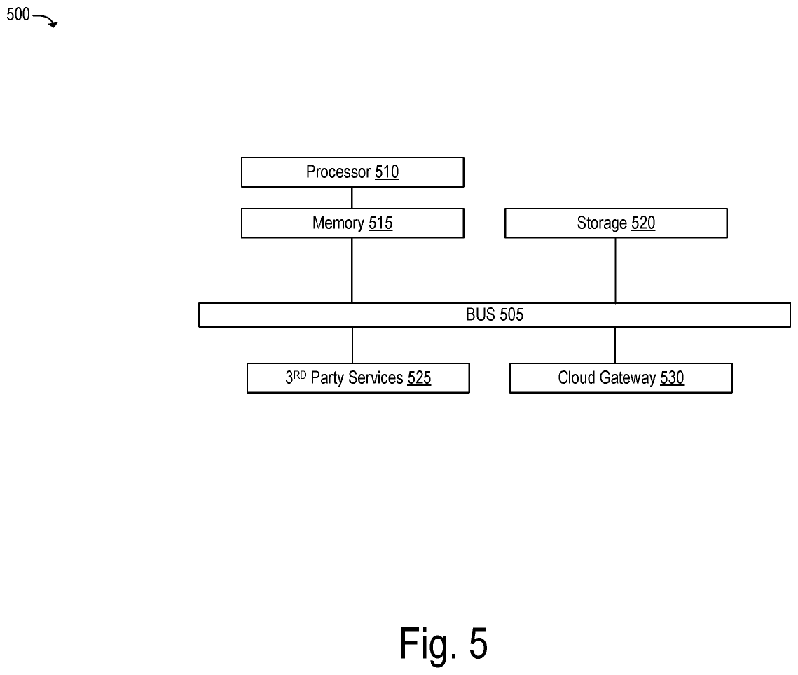

Referring to FIG. 5, FIG. 5 is a schematic illustrating a computing system 500 that may be used to implement various features of embodiments described in the disclosed subject matter. The terms components, entities, modules, surface, and platform, when used herein, may refer to one of the many embodiments of a computing system 500. The computing system 500 may be a single computer, a co-located computing system, a cloud-based computing system, or the like. The computing system 500 may be used to carry out the functions of one or more of the features, entities, and/or components of a software project.

The exemplary embodiment of the computing system 500 shown in FIG. 5 includes a bus 505 that connects the various components of the computing system 500, a processor 510 coupled to a memory 515, and at least one storage 520. The processor 510 is an electronic circuit that executes instructions that are passed to it from the memory 515. Executed instructions are passed back from the processor 510 to the memory 515. The interaction between the processor 510 and memory 515 allow the computing system 500 to perform computations, calculations, and various computing to run software applications.

Examples of the processor 510 include central processing units (CPUs), graphics processing units (GPUs), field programmable gate arrays (FPGAs), complex programmable logic devices (CPLDs), and application specific integrated circuits (ASICs). The memory 515 stores instructions that are to be passed to the processor 510 and receives executed instructions from the processor 510. The memory 515 also passes and receives instructions from all other components of the computing system 500 through the bus 505. For example, a computer monitor may receive images from the memory 515 for display. Examples of memory include random access memory (RAM) and read only memory (ROM). RAM has high speed memory retrieval and does not hold data after power is turned off. ROM is typically slower than RAM and does not lose data when power is turned off.

The storage 520 is intended for long term data storage. Data in the software project such as computer readable specifications, code, designs, and the like may be saved in a storage 520. The storage 520 may be stored at any location including in the cloud. Various types of storage include spinning magnetic drives and solid-state storage drives.

The computing system 500 may connect to other computing systems in the performance of a software project. For instance, the computing system 500 may send and receive data from 3^{rd} party services such as Office 365 and Adobe. Similarly, users may access the computing system 500 via a cloud gateway 530. For instance, a user on a separate computing system may connect to the computing system 500 to access data, interact with the run entities 108, and even use 3^{rd} party services 525 via the cloud gateway.

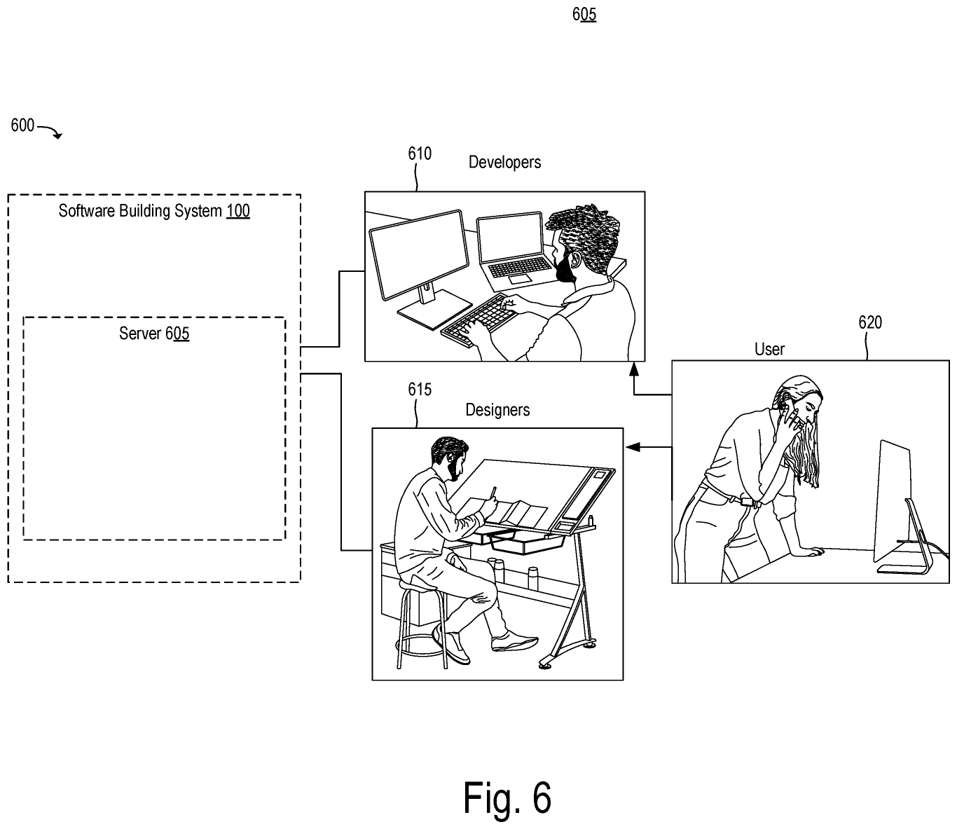

Referring to FIG. 6. FIG. 6 is a schematic diagram of a system 600 in an embodiment of the disclosed subject matter. In an exemplary embodiment, the system 600 comprises the software building system 100, one or more users 620, one or more developers 610, and one or more designers 615. In the embodiment shown for the system 600, the software building system 100 comprises a server 605. The server 605 may be a computing system 500.

In the exemplary embodiment shown in FIG. 6, the server 605 is in communication with one or more users 620, one or more developers 610, and one or more designers 615. Various embodiments may include additional personnel or computing resources that produce code, content, or the like for the software application. For example, the server 605 may be in communication with one or more quality assurance engineers to assemble, test, and package the software application.

In an exemplary embodiment, the server 605 may transfer allocating units to the users 620. The users 620, as used herein, may be referred to an individual person, small business owner/manager, large business owner/manager, hotel manager, restaurant manager, and the like. The users 620 may distribute the allocating units to various personnel, computing resources, or other services to work on the software application. In an exemplary embodiment, allocating units may be referred to as tokens, points, or the like. As used herein, the allocating units are commonly referred to as points.

In an exemplary embodiment, the users 620 may distribute points to developers 610 and designers 615. The developers 610, as used herein, may be referred to as experts, developer experts, coders, software engineers, engineers, and the like. In various embodiments, the one or more developers 610 may be supplied by an onboarding system 116. In various embodiments, the users 620 contact and selects the one or more developers 610.

In an exemplary embodiment, the BRAT 122 may determine the one or more developers 610 for a software project. In one implementation, the BRAT 122 may determine the one or more developers 610 for the users 620 based on multiple qualities of a software application and/or multiple software application visions. For instance, the BRAT 122 may determine the one or more developers 610 for a small-size software application, a medium-sized software application, and a large medium-sized software application. In another instance, the BRAT 122 may determine the one or more developers 610 for a consumer-based software application and an industry-based software application where a consumer-based software application has a focus on large volume consumer communication and an industry-based software application has a focus on intimate communication with a small number of industries.

The designers 615, as used herein, may be referred to as artists, web designers, and the like. The designers 615 may have different skill levels and different skill areas. In an exemplary embodiment, the BRAT 122 may provide the one or more designers 615 along with their talent set. A user may use the provided information on designers to allocate resources to designers 615 in a way that promotes the users 620 vision of the software application.

The system 600 allows the users 620 freedom to distribute points according to their vision and limited resources for the software application project. Accordingly, the system 600 maximizes creativity at a high level by allowing the users 620 strategic control over high-level management decisions in the software project. The users 620 is not limited to arbitrary or abstract criteria for selecting developers or designers or how to allocate points to developers or designers. Even where the cloud allocation tool 148 determines a number of points for the users 620, the system 600 provides for the users 620 to distribute those points without limitations.

The distribution of points from the users 620 to developers 610, designers 615, or the like is a signal to the developers 610 and designers 615 to provide an amount of work commensurate with the number of points transferred. The server 605 may provide lower management level decisions to the developers 610, designers 615, or other personnel or computing resources based on the points allocated to them by the users 620. In an exemplary embodiment, the server 605 may provide payment to the developers 610 and designers 615 based on the points distributed to them.

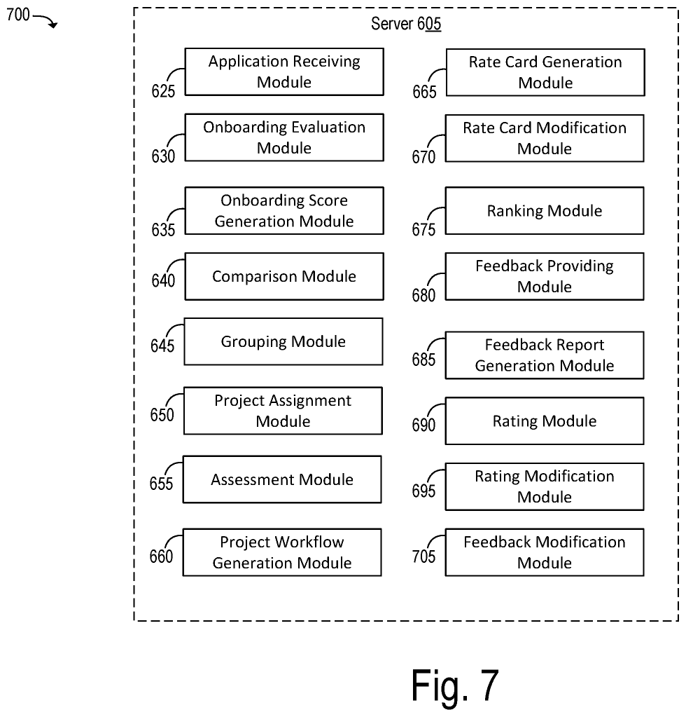

Referring to FIG. 7, FIG. 7 illustrates an exploded view 700 of the server 605 of the system 600 of FIG. 6 in an embodiment of the disclosed subject matter. As shown, the server 605 includes an application receiving module 625, an onboarding evaluation module 630, an onboarding score generation module 635, a comparison module 640, a grouping module 645, a project assignment module 650, an assessment module 655, a project workflow generation module 660, a rate card generation module 665, a rate card modification module 670, a ranking module 675, a feedback providing module 680, a feedback report generation module 685, a rating module 690, a rating modification module 695, and a feedback modification module 705. The functionality of each module is explained in further detail below.

In an exemplary embodiment, the application receiving module 625 receives an application request from the one or more developers 610. The one or more developers 610 may submit their application request to the software building system 100 if they are interested in a partnership or working on one or more projects offered by the software building system 100. The application request includes at least one of a personal information associated with the one or more developers, experience of the one or more developers, education details, and certifications of the one or more developers. The one or more developers may manually type the application request information in a platform offered by the software building system 100 upon successful registration. The one or more developers 610 may also choose to attach documents or files as proof to support their application request.

The personal information associated with the one or more developers 610 may include their name, date of birth, address, phone number, email address, photographs, profession (salaried, non-salaried, business owner), and the like. The experience corresponds to areas of work or research that the one or more developers 610 have been involved in. In an example, the one or more developers 610 may be asked to provide information such as previous employer/work details, areas of expertise, achievements, promotions, sample work or research conducted, and the like. Further, the education details and certifications correspond to a schooling or learning background associated with the one or more developers 610. The one or more developers 610 may be asked to provide information such as degree certificate, course certificate, transcripts, and the like.

In an exemplary embodiment, the onboarding evaluation module 630 evaluates the one or more developers 610 based on an evaluation criteria once the application request has been submitted by them. The evaluation criteria is based on one or more factors. The one or more factors may include at least one of a background of the one or more developers, works performed by the one or more developers, and a performance of the one or more developers in an onboarding assessment. The onboarding assessment relates to a test that is automatically generated by the onboarding evaluation module 630 that the one or more developers 610 are required to take. For instance, if the background of the one or more developers 610 is programming and the works performed by them are primarily in C++ or Java programming languages, the onboarding assessment generated by the onboarding evaluation module 630 will largely cover questions in those areas. Thus, the onboarding evaluation module 630 is capable of analyzing a background and work experience of the one or more developers 610, and accordingly generates an appropriate onboarding assessment quiz for them to take.

In an exemplary embodiment, the onboarding score generation module 635 generates an onboarding score for the one or more developers 610 based on the evaluation criteria analyzed by the onboarding evaluation module 630. The onboarding score is used for indicating a capability of the one or more developers 610. The onboarding score generation module 635 takes the performance of the one or more developers 610 in the onboarding assessment into strong consideration when generating the onboarding score. For instance, the onboarding score may be between a range of 1 to 100 where a higher score corresponds to better onboarding chances for the one or more developers 610.

In an exemplary embodiment, the comparison module 640 compares the onboarding score determined by the onboarding score generation module 635 with a threshold limit. In an example, the threshold limits may be between one or more ranges. The first range may lie between 0-60, the second range may lie between 61-70, the third range may lie between 71-80, and the fourth range may lie between 81-100.

In an exemplary embodiment, the grouping module 645 groups the one or more developers 610 into one or more groups based on the comparison between the onboarding score and threshold limits by the comparison module 640. The one or more groups may include a beginner group, an intermediate group, and an advanced group. The grouping module 645 groups the one or more developers 610 based on the one or more ranges that the onboarding score falls into. For instance, if the onboarding score is within the first range, then the grouping module 645 assigns no group to the one or more developers 610. A minimum onboarding score of 60 is required for assigning a group. If the onboarding score is within the second range, the grouping module 645 groups the one or more developers 610 into the beginner group. If the onboarding score is within the third range, the grouping module 645 groups the one or more developers 610 into the intermediate group. If the onboarding score is within the fourth range, the grouping module 645 groups the one or more developers 610 into the advanced group.

In an exemplary embodiment, the project assignment module 650 assigns one or more projects to the one or more developers 610 based on the groups that the grouping module 645 has assigned for them. This ensures that the one or more developers 610 are provided with work of their level and comfort that they will be able to timely complete. This also prevents mismatch or incorrect allocation of projects to the one or more developers 610.

In an exemplary embodiment, the assessment module 655 assesses the one or more developers 610 while working on the one or more projects assigned by the project assignment module 650. The assessment module 655 may assess the one or more developers 610 based on one or more parameters. The one or more parameters may be based on at least one of an average time taken to complete each project, a work quality, a project complexity, and a value of the project. Each parameter is explained in further detail below.

The average time interval is obtained by dividing the total time taken by each of the developers 610 to complete the one or more projects by the total number of developers who have worked on the one or more projects. The average time interval is a numerical value that may be represented in minutes or hours. The average time interval also helps project managers or the one or more users 620 who have raised requests for completing the one or more projects to figure out which projects are taking more time when compared to others and which projects would require additional persons or assistance to timely complete.

The work quality or quality of work corresponds to a standard, accuracy, and thoroughness of the one or more projects completed and submitted by the one or more developers 610. The assessment module 655 may scan the work submitted by the one or more developers 610 for accessing the quality. In an example, if the one or more developers 610 have submitted a code written in a programming language known to a person skilled in the art, the assessment module 655 scans the code and views the comments, bugs, syntax errors at the different compile stages. The assessment module 655 then generates a quality report based on the scanning.

The project complexity refers to a difficulty level of the one or more projects. For instance, each project may be grouped into either an easy project, intermediate project, or a difficult project. The project complexity details may be provided by the one or more users 620 or project managers at the time of allocating the one or more projects. Further, the project value corresponds to a value that each project holds to the project managers, stakeholders, clients, customers, and the like. The project value may be determined based on an earned value, planned value, project cost, delays in the project, and the like.

Based on the assessment conducted, the assessment module 655 generates an assessment score for the one or more developers 610. The assessment score may be generated based on an assessment criteria. The assessment criteria is based on at least one of a time taken by the one or more developers 610 to complete each project, a work quality, and a comparison between the time taken with an actual time to be taken for project completion. The actual time corresponds to a time set by the assessment module 655 or manually by the one or more users 620 or project managers. The actual time refers to a suitable time that the one or more developers 610 should take to complete each project. In an example, if the time taken by the one or more developers 610 to complete a project is 12 hours and the actual time for this project is set to be 15 hours, this gives an indication that developers 610 are capable of timely completing the project. This will thus boost their assessment score. Further, the assessment score may be between a range of 1 to 10.

In an exemplary embodiment, the project workflow generation module 660 generates a project workflow for completing the one or more projects. The project workflow includes a project timeline and one or more building blocks that implement one or more features assigned for each project. The one or more building blocks are reusable pieces of code that implement one or more functionalities of the one or more features assigned for each project. The generated project workflow is then communicated to the one or more developers 610 selected to work on each project.

In an exemplary embodiment, the rate card generation module 665 generates a rate card for the one or more developers 610 based on the assessment score generated by the assessment module 655. The rate card summarizes one or more hourly rates to be paid to the one or more developers 610 while working on each project. The hourly rate may differ between each of the projects and depends on factors such as project complexity, background of the developers 610. project deadlines, project cost, and the like. In an example, if the project is a difficult project, has an early deadline, and the assessment score determined for the one or more developers 610 is high (above 8), then the rate card generated will direct to pay the one or more developers 610 a higher hourly rate or good hourly rate. The rate card generation module 665 is capable of generating suitable hourly rates to pay for the one or more developers 610 for different projects based on the project background, the developers 610 background, and the assessment score of the one or more developers 610 determined by the assessment module 655. The invoicing/payments of the one or more developers 610 is an automatic process without having them to manually provide any information.

In an exemplary embodiment, the rate card modification module 670 receives one or more inputs from the one or more developers 610 to modify their rate card generated by the rate card generation module 665. For instance, if the one or more developers 610 feel that the hourly rate for each project mentioned in the rate card is less or should be increased, they can provide their feedback. The one or more developers 610 may provide their feedback or one or more inputs relating to their rate card via written message, voice message, email message, and the like. The one or more developers 610 are expected to clearly explain why they feel that they should be getting a greater hourly rate. Once their feedback and reasoning is taken into consideration by the one or more users 620 or project managers, the rate card modification module 670 generates and shares a revised rate card to the one or more developers 610. The revised rate card is generated and shared with the one or more developers 610 upon their acknowledgement of the revised invoicing/hourly rates presented to them based on their feedback and reasoning. Thus, the rate card modification module 670 allows the one or more developers 610 to duly negotiate their invoice/hourly rates for each project.

Further, based on the revised rate card, the project assignment module 650 may assign one or more new projects to the one or more developers 610. For instance, if the invoicing/hourly rates for the one or more developers 610 is increased, the project assignment module 650 may then assign projects that are more complex and would require more effort. Thus, the one or more developers 610 may gain an experience of working one new or other projects based on their revised rate card.

In an exemplary embodiment, the ranking module 675 ranks the one or more developers 610 based on their performance based on one or more parameters. The one or more parameters are based on at least one of the assessment score generated by the assessment module 655, the rate card generated by the rate card generation module 665, the revised rate card generated by the rate card modification module 670, and the one or more new projects assigned to the one or more developers by the project assignment module 650. The ranking module 675 allows the one or more developers 610 to see their performance when compared with other developers 610. This will help in motivating themselves to do better.

In an exemplary embodiment, the feedback providing module 680 provides feedback to the one or more developers 610 while working on the projects. In an example, the feedback may be real-time feedback or live feedback in which the feedback providing module 680 is able to directly interact with the one or more developers 610. The feedback may be presented to the one or more developers 610 via at least one of a written message, voice message, an email message, and the like. The feedback may be presented to the one or more developers 610 on their respective device (not shown) while working on the one or more projects. In an example, if the developers 610 are working on a coding project and the assessment module 655 determines that there are less bugs or errors in the code, the feedback providing module 680 may then prompt a message stating, “Good Work” or “Less Errors Found, Keep it Up”. Such feedback may motivate the one or more developers 610 to perform better and also ensure that they remain concentrated.

In an exemplary embodiment, the feedback report generation module 685 generates a feedback report for the one or more developers 610 based on the feedback provided by the feedback providing module 680. The feedback report is a detailed report that includes the feedback provided by the one or more developers 610, feedback/inputs provided by the one or more users 620 or project managers, concerns raised by the one or more developers 610 or one or more users 620, significant achievements made by the one or more developers, the invoicing/hourly rate determined by the rate card generation module 665, any modifications in the invoicing/hourly rate determined by the rate card modification module 670, and the like.

Further, the generated feedback report is assessable to one or more authorized persons within an entity that has requested to complete the one or more projects. The one or more authorized persons may be the one or more users 620 or project managers. The entity may refer to the organization/person who has requested for the one or more projects to be completed. In an example, the entity may be an individual, small entity, medium-sized entity, large entity, and the like. As the feedback report generated by the feedback report generation module 685 includes an analysis of multiple factors, the one or more users 620, project managers, or the entity would be able to visualize the overall performance of the one or more developers 610 in a better way. The generated feedback report is also helpful for the one or more developers 610 as it summarizes the multiple factors for each project that they have worked on. In case they want to refer back to such project details in the future, the generated feedback report will be of assistance.

In an exemplary embodiment, the rating module 690 rates the one or more developers 610 based on the feedback mentioned in the feedback report generated by the feedback report generation module 685. The rating of each of the developers 610 may be determined by comparing an overall performance of one developer with a performance of at least two developers. The rating of the one or more developers 610 may be represented as a percentage or percentile. Further, the rating of the one or more developers 610 may also be presented using a graph or a dashboard. For instance, if the developers 610 lie in an above 80% percentage/percentile, this indicates that their overall performance is 80% better than the performance of others working or who have worked on the same project. Providing such a percentage/percentile value will allow the developers 610 to clearly visualize how they stand when compared to others.

In an exemplary embodiment, the rating modification module 695 receives one or more inputs from the one or more developers 610 to modify their rating generated by the rating module 690. For instance, if the one or more developers 610 feel that their rating generated by the rating module 690 is less or should be increased, they can provide their inputs regarding the same. The one or more developers 610 may provide their feedback or one or more inputs relating to their rating via written message, voice message, email message, and the like. The one or more developers 610 are expected to clearly explain why they feel that they deserve a higher rating. Once their feedback and reasoning is taken into consideration by the one or more users 620 or project managers, the rating modification module 695 generates and shares a revised rating to the one or more developers 610. Thus, the rating modification module 695 allows the one or more developers 610 to duly negotiate their rating when compared to others.

In an exemplary embodiment, the feedback modification module 705 modifies the feedback report generated by the feedback report generation module 685 based on the revised rating determined by the rating modification module 695. Thus, the one or more developers 610, one or more users 620, and project managers will be provided with updated versions of the feedback report during different instances of their project.

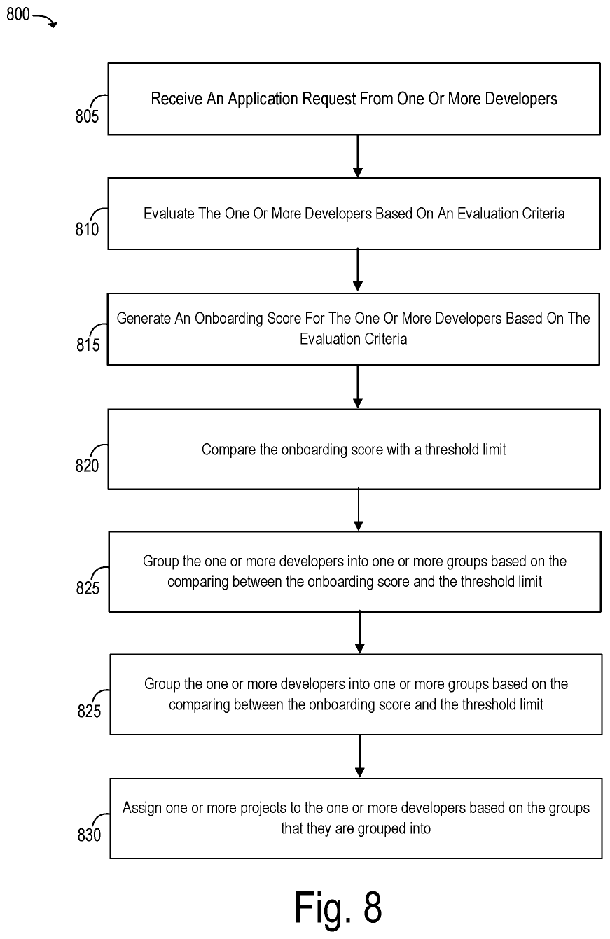

Referring to FIG. 8. FIG. 8 is a flow diagram 800 of an embodiment of the disclosed subject matter. The flow diagram 800 illustrates a method for onboarding one or more developers 610. The software application may be any executable process on a computer system comprising instructions, designs, art, user interfaces, audio recordings, music, video, and the like. The software application is not limited to any commercial or consumer application. For example, the software application may be a utility application, a production application, a document generator, a game, and artistic application, and accounting application, or the like. Steps 805-830 of the flow diagram 800 may be executed using the server 605 of FIGS. 6-7. Each step is explained in further detail below.

At step 805, the application receiving module 625 receives an application request from the one or more developers 610. The application request includes at least one of a personal information associated with the one or more developers, experience of the one or more developers, education details, and certifications of the one or more developers.

At step 810, the onboarding evaluation module 630 evaluates the one or more developers 610 based on an evaluation criteria once the application request has been submitted by them. The evaluation criteria is based on one or more factors. The one or more factors may include at least one of a background of the one or more developers, works performed by the one or more developers, and a performance of the one or more developers in an onboarding assessment. The onboarding assessment relates to a test that is automatically generated by the onboarding evaluation module 630 that the one or more developers 610 are required to take. The onboarding assessment may include multiple choice questions, fill in the blank questions, practical questions, programming questions, case study questions, and the like.

At step 815, the onboarding score generation module 635 generates an onboarding score for the one or more developers 610 based on the evaluation criteria analyzed in step 810. The onboarding score is used for indicating a capability of the one or more developers 610. The performance of the one or more developers 610 in the onboarding assessment is taken into strong consideration when generating the onboarding score.

At step 820, the comparison module 640 compares the onboarding score determined with a threshold limit. In an example, the threshold limits may be between one or more ranges. The first range may lie between 0-60, the second range may lie between 61-70, the third range may lie between 71-80, and the fourth range may lie between 81-100.

At step 825, the grouping module 645 groups the one or more developers 610 into one or more groups based on the comparison between the onboarding score and threshold limits in step 820. The one or more groups may include a beginner group, an intermediate group, and an advanced group. The one or more developers 610 are grouped based on the one or more ranges that the onboarding score falls into. For instance, if the onboarding score is within the first range, then no group is assigned to the one or more developers 610. If the onboarding score is within the second range, the one or more developers 610 are grouped into the beginner group. If the onboarding score is within the third range, the one or more developers 610 are grouped into the intermediate group. If the onboarding score is within the fourth range, the one or more developers 610 are grouped into the advanced group.

At step 830, the project assignment module 650 assigns one or more projects to the one or more developers 610 based on the groups that have been assigned for them in step 825. This ensures that the correct set of projects are assigned to the one or more developers 610 based on their caliber.

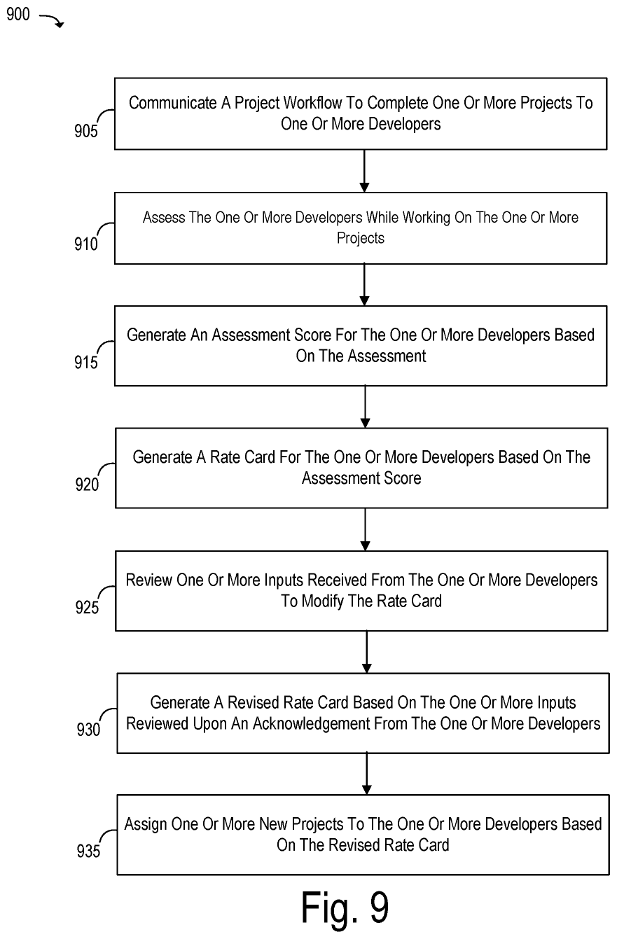

Referring to FIG. 9, FIG. 9 is a flow diagram 900 of an embodiment of the disclosed subject matter. The flow diagram 900 illustrates a method for assessing the one or more developers 610 in an embodiment of the disclosed subject matter. Steps 905-935 of the flow diagram 900 may be executed using the server 605 of FIGS. 6-7. Each step is explained in further detail below.

At step 905, the project workflow generation module 660 generates a project workflow for completing the one or more projects. The project workflow includes a project timeline and one or more building blocks that implement one or more features assigned for each project. The generated project workflow is then communicated to the one or more developers 610 selected to work on each project.

At step 910, the assessment module 655 assesses the one or more developers 610 while working on the one or more projects assigned to them. The one or more developers 610 are accessed based on one or more parameters. The one or more parameters may be based on at least one of an average time taken to complete each project, a work quality, a project complexity, and a value of the project.

At step 915, the assessment module generates an assessment score for the one or more developers 610. The assessment score may be generated based on an assessment criteria. The assessment criteria is based on at least one of a time taken by the one or more developers 610 to complete each project, a work quality, and a comparison between the time taken with an actual time to be taken for project completion.

At step 920, the rate card generation module 665 generates a rate card for the one or more developers 610 based on the assessment score generated in step 915. The rate card summarizes one or more hourly rates to be paid to the one or more developers 610 while working on each project.

At step 925, the rate card modification module 670 receives one or more inputs from the one or more developers 610 to modify their rate card generated in step 920. For instance, if the one or more developers 610 feel that the hourly rate for each project mentioned in the rate card is not up to their expectations, they can provide their feedback. The one or more developers 610 may provide their feedback or one or more inputs relating to their rate card via written message, voice message, email message, and the like.

At step 930, the rate card modification module 670 generates a revised rate card for the one or more developers 610. The revised rate card is generated once their feedback or one or more inputs have been verified and processed. The one or more developers 610 are then required to acknowledge the revised rate communicated with them. Upon acknowledgement, the revised rate card is generated and shared with them.

At step 935, the project assignment module 650 assigns one or more new projects to the one or more developers 610 based on the revised rate card. For instance, if the invoicing/hourly rates for the one or more developers 610 is increased, they may then be assigned projects that are more complex and would require more effort.

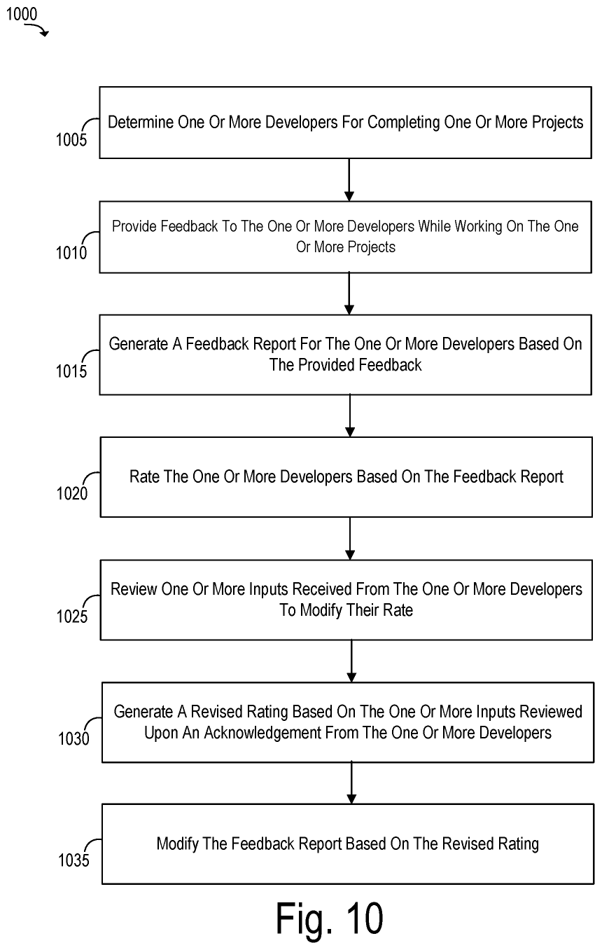

Referring to FIG. 10, FIG. 10 is a flow diagram 1000 of an embodiment of the disclosed subject matter. The flow diagram 1000 illustrates a method for providing feedback to the one or more developers 610 working on one or more projects in an embodiment of the disclosed subject matter. Steps 1005-1035 of the flow diagram 1000 may be executed using the server 605 of FIGS. 6-7. Each step is explained in further detail below.

At step 1005, the server 605 determined one or more developers 610 for completing the one or more projects. The one or more developers 610 may be determined based on one or more parameters. The one or more parameters is based on at least one of a background of the one or more developers 610, works performed by the one or more developers 610, a performance of the one or more developers 610 in the onboarding assessment, and the like.

At step 1010, the feedback providing module 680 provides feedback to the one or more developers 610 while working on the projects. In an example, the feedback may be real-time feedback or live feedback in which the feedback providing module 680 is able to directly interact with the one or more developers 610. The feedback may be presented to the one or more developers 610 via at least one of a written message, voice message, an email message, and the like.

At step 1015, the feedback report generation module 685 generates a feedback report for the one or more developers 610 based on the feedback provided to them in step 1010. The feedback report is a detailed report that includes the feedback provided by the one or more developers 610, feedback/inputs provided by the one or more users 620 or project managers, concerns raised by the one or more developers 610 or one or more users 620, significant achievements made by the one or more developers, the invoicing/hourly rate, any modifications in the invoicing/hourly rate, and the like.

At step 1020, the rating module 690 rates the one or more developers 610 based on the feedback mentioned in the feedback report generated in step 1015. The rating of each of the developers 610 may be determined by comparing an overall performance of one developer with a performance of at least two developers. The rating of the one or more developers 610 may be represented as a percentage or percentile.

At step 1025, the rating modification module 695 receives one or more inputs from the one or more developers 610 to modify their rating generated by the rating module 690. For instance, if the one or more developers 610 feel that their rating generated by the rating module 690 is less or should be increased, they can provide their inputs regarding the same. The one or more developers 610 may provide their feedback or one or more inputs relating to their rating via written message, voice message, email message, and the like.

At step 1030, the rating modification module 695 generates and shares a revised rating to the one or more developers 610. The revised rating is shared by taking the feedback and reasoning provided by the one or more developers in step 1025 into strong consideration.

At step 1035, the feedback modification module 705 modifies the feedback report generated in step 1015 based on the revised rating determined in step 1030.

The system and method described herein is capable of onboarding one or more developers for working on one or more projects based on their performance in an onboarding assessment. The onboarding assessment is automatically generated based on the background of the developers, work experience of the developers, projects worked on by the developers, and the like. Thus, the project managers or entities assigning and managing the projects may not manually access the developers that they are looking to partner with, as the system and method described herein is capable of evaluating the developers based on an auto-generated assessment test/quiz.

The system and method described herein is further capable of generating a rate card, which summarizes one or more hourly rates to be paid to each developer working on each of the projects. The rate card may be generated based on an analysis of the background of the developers and their performance in the auto-generated assessment test/quiz. This process is automated and required no or minimal manual intervention. Further, the system and method described herein is capable of allowing the selected developers to negotiate their rates across multiple projects. For instance, if the developer feels that the payment rate assigned to them for one or more projects is not up to their expectation, they will be provided with an option to negotiate their hourly payment rate.

The system and method described herein is further capable of providing real-time or live feedback to the developers while working on each project. The feedback may be provided to the developers alongside while they are working. Such feedback may allow the developers to catch their mistakes/comments instantly, may motivate them to perform better, and also ensure that they remain concentrated. Based on the feedback provided to the developers, the hourly payment rates may also vary. In case of good feedback, their may be possibilities that they receive an increase in their hourly payment rate while working on a particular project. Thus, the hourly payment rates assigned for each develop are not fixed and may vary based on their performance. Thus, the developers are provided with an opportunity to receive additional payments in case of better work products or better output results.

The foregoing description of the embodiments has been provided for purposes of illustration and not intended to limit the scope of the present disclosure. Individual components of a particular embodiment are generally not limited to that particular embodiment, but are interchangeable. Such variations are not to be regarded as a departure from the present disclosure, and such modifications are considered to be within the scope of the present disclosure.

The embodiments herein and the various features and advantageous details thereof are explained with reference to the non-limiting embodiments in the following description. Descriptions of well-known components and processing techniques are omitted so as to not obscure the embodiments herein. The examples used herein are intended merely to facilitate an understanding of ways in which the embodiments herein may be practiced and to further enable those of skill in the art to practice the embodiments herein. Accordingly, the examples may not be construed as limiting the scope of the embodiments herein.

The foregoing description of the specific embodiments so fully reveal the general nature of the embodiments herein that others can, by applying current knowledge, readily modify and/or adapt for various applications such specific embodiments without departing from the generic concept, and, therefore, such adaptations and modifications may and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments, those skilled in the art will recognize that the embodiments herein can be practiced with modification within the spirit and scope of the embodiments as described herein.

Any discussion of documents, acts, materials, devices, articles or the like that has been included in this specification is solely for the purpose of providing a context for the disclosure. It is not to be taken as an admission that any of these matters form a part of the prior art base or were common general knowledge in the field relevant to the disclosure as it existed anywhere before the priority date of this application.

The numerical values mentioned for the various physical parameters, dimensions or quantities are approximations and it is envisaged that the values higher/lower than the numerical values assigned to the parameters, dimensions or quantities fall within the scope of the disclosure, unless there is a statement in the specification specific to the contrary.

While considerable emphasis has been placed herein on the components and component parts of the embodiments, it will be appreciated that many embodiments can be made and that many changes can be made in the embodiments without departing from the principles of the disclosure. These and other changes in the embodiment as well as other embodiments of the disclosure will be apparent to those skilled in the art from the disclosure herein, whereby it is to be distinctly understood that the foregoing descriptive matter is to be interpreted merely as illustrative of the disclosure and not as a limitation.

1. A system for providing feedback to one or more developers working on one or more projects, the system comprising:
a processor coupled to a memory, the processor configured to:
determine the one or more developers for completing the one or more projects, wherein the one or more developers are determined based on one or more parameters;
provide feedback to the one or more developers while working on the one or more projects; and
generate a feedback report for the one or more developers based on the provided feedback, wherein the feedback report is accessible to one or more authorized persons within an entity that has requested to complete the one or more projects.

2. The system of claim 1, wherein the one or more parameters for determining the one or more developers is based on at least one of a background of the one or more developers, works performed by the one or more developers, and a performance of the one or more developers in an onboarding assessment.

3. The system of claim 1, wherein the feedback is presented to the one or more developers by at least one of a written message, voice message, and an email message.

4. The system of claim 1, wherein the processor is further configured to rate the one or more developers based on the feedback report.

5. The system of claim 4, wherein the processor is further configured to receive one or more inputs from the one or more developers to modify their rate.

6. The system of claim 5, wherein the processor is further configured to:
review the one or more inputs provided by the one or more developers; and
generate a revised rating based on the one or more inputs reviewed upon an acknowledgment from the one or more developers.

7. The system of claim 6, wherein the processor is further configured to modify the feedback report based on the revised rating.

8. A method for assessing one or more developers, the method comprising:
determining the one or more developers for completing the one or more projects, wherein the one or more developers are determined based on one or more parameters;
providing feedback to the one or more developers while working on the one or more projects; and
generating a feedback report for the one or more developers based on the provided feedback, wherein the feedback report is accessible to one or more authorized persons within an entity that has requested to complete the one or more projects.

9. The method of claim 8, wherein the one or more parameters for determining the one or more developers is based on at least one of a background of the one or more developers, works performed by the one or more developers, and a performance of the one or more developers in an onboarding assessment.

10. The method of claim 8, wherein the feedback is presented to the one or more developers by at least one of a written message, voice message, and an email message.

11. The method of claim 8, further comprising rating the one or more developers based on the feedback report.

12. The method of claim 11, further comprising receiving one or more inputs from the one or more developers to modify their rate.

13. The method of claim 12, further comprising to:
reviewing the one or more inputs provided by the one or more developers; and
generating a revised rating based on the one or more inputs reviewed upon an acknowledgment from the one or more developers.

14. The method of claim 13, further comprising modifying the feedback report based on the revised rating.

15. A computer readable storage medium having data stored therein representing software executable by a computer, the software comprising instructions that, when executed, cause the computer readable storage medium to perform:
determining one or more developers for completing the one or more projects, wherein the one or more developers are determined based on one or more parameters;
providing feedback to the one or more developers while working on the one or more projects;
generating a feedback report for the one or more developers based on the provided feedback, wherein the feedback report is accessible to one or more authorized persons within an entity that has requested to complete the one or more projects.

16. The computer readable storage medium of claim 15, wherein the one or more parameters for determining the one or more developers is based on at least one of a background of the one or more developers, works performed by the one or more developers, and a performance of the one or more developers in an onboarding assessment.

17. The computer readable storage medium of claim 15, wherein the feedback is presented to the one or more developers by at least one of a written message, voice message, and an email message.

18. The computer readable storage medium of claim 15, wherein the instructions further cause the computer readable storage medium to perform rating the one or more developers based on the feedback report.

19. The computer readable storage medium of claim 18, wherein the instructions further cause the computer readable storage medium to perform receiving one or more inputs from the one or more developers to modify their rate.

20. The computer readable storage medium of claim 19, wherein the instructions further cause the computer readable storage medium to perform:
reviewing the one or more inputs provided by the one or more developers; and
generating a revised rating based on the one or more inputs reviewed upon an acknowledgment from the one or more developers.
